(19) United States
(12) Patent Application Publication
(10) Pub. No.: US 2005/0082397 A1
(43) Pub. Date: Apr. 21, 2005

(54) Fluid injection nozzle

(76) Inventor: Kyoung-Heon Heo, Hwasung-city (KR)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/864,997

(22) Filed: Jun. 10, 2004

(30) Foreign Application Priority Data
Oct. 17, 2003 (KR) 10-2003-0072489

(51) Int. Cl. B05B 1/30; B05B 1/34; F02G 5/00; B05B 1/00

(52) U.S. Cl. 239/596; 239/533.14; 239/600

(57) ABSTRACT

A fluid injection nozzle for treating a substrate includes a first plate having a first tip, and a second plate having a second tip, the second tip being coupled to the first plate by a fastener. The first and second plates define a fluid channel, and the first and second tips have lengths different from each other.

### BACKGROUND OF THE DISCLOSURE

1. Field of the Disclosure

The disclosure relates to a fluid injection nozzle, and: more particularly to a fluid injection nozzle that can be used to treat a surface of a flat display panel and spray the fluid in a predetermined direction.

2. Description of the Related Art

A fluid injection nozzle used for treating a surface of a flat display panel is disclosed in Korean Utility Model No. 20-0305052. The nozzle disclosed in this utility model is designed having tips different in length from each other. The nozzle is disposed to be inclined with respect to a treating surface of the panel to treat the surface by injecting the fluid on the surface. The inclination of the nozzle is to improve the treating efficiency by injecting the fluid in a predetermined direction.

However, when the nozzle is inclined in a state where it is disposed close to the surface, the nozzle may contact the panel, deteriorating the treating efficiency. In addition, even when the nozzle is disposed to be inclined, the fluid may not be injected in the predetermined direction. That is, if the fluid is injected in a direction identical to a direction where the panel is advanced, eddy current and negative pressure may be generated, causing vibration of the substrate to deteriorate the treating efficiency.

### SUMMARY OF THE DISCLOSURE

Accordingly, the disclosure is directed to a fluid injection nozzle that substantially obviates one or more problems due to limitations and disadvantages of the related art.

The disclosure provides a fluid injection nozzle for treating a surface of a flat display panel, that can be installed in an injector such that it is sufficiently inclined with respect to a substrate and that can inject fluid in a predetermined direction even when it is installed such that it is not inclined with respect to the substrate.

The fluid injection nozzle for treating a substrate includes a first plate having a first tip, and a second plate having a second tip, the second tip being coupled to the first plate by a fastener, wherein the first and second plates define a fluid channel and the first and second tips have lengths different from each other.

Preferably, one of the first and second plates, which has the tip having a length less than the other, is disposed at a downstream side of the substrate with respect to a direction where the substrate is advanced.

Both the foregoing general description and the following detailed description are exemplary and explanatory and are intended to provide further explanation of the disclosed injector nozzle.

### BRIEF DESCRIPTION OF THE DRAWINGS

The accompanying drawings, which are included to provide a further understanding of the disclosure and are incorporated in and constitute a part of the disclosure, illustrate embodiments of the injection nozzle, and together with the description serve to explain the principle thereof. In the drawings:

FIG. 1 is a perspective view of a fluid injection nozzle according to a preferred embodiment of the disclosure;

FIG. 2 is a sectional view taken along line A-A of FIG. 1; and

FIG. 3 is a view illustrating the operation of the disclosed injection nozzle.

### DETAILED DESCRIPTION

Reference will now be made in detail to the preferred embodiments of the disclosed injection nozzle, examples of which are illustrated in the accompanying drawings. Wherever possible, the same reference numbers will be used throughout the drawings to refer to the same or like parts.

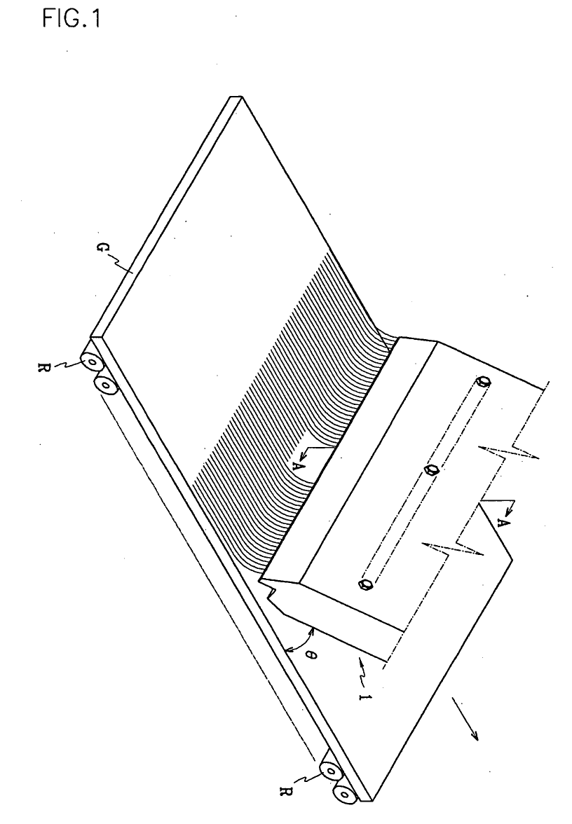

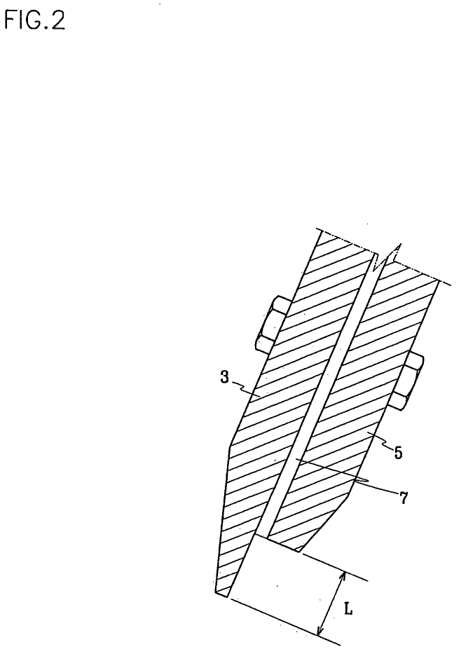

FIGS. 1 and 2 show a fluid injection nozzle 1 inclined at a predetermined angle E) with respect to a surface of a substrate G.

The nozzle 1 includes first and second plates 3 and 5, respectively, each having a predetermined width. The first and second plates 3 and 5 are coupled to each other by a fastener such as a bolt/nut assembly, and a fluid channel 7 is defined between the first and second plates 3 and 5. A tip portion of the second plate 5 has a length less than that of the first plate 5 by a length L. In addition, it is preferable that the second plate 5 is disposed on a downstream side with respect to an advancing direction (an arrow direction in the drawing) of the substrate G. That is, it is preferable that the nozzle is disposed such that a plate having a tip length less than that of the other plate is disposed on the upstream side.

The fluid channel 9 is defined by forming grooves on the facing surfaces of the first and second plates 3 and 5, or by providing separating gap-forming members between the first and second plates 3 and 5.

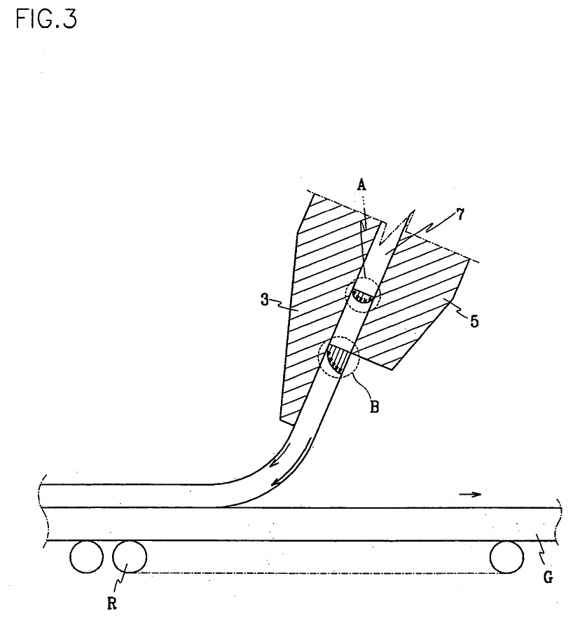

The operation of the injection nozzle will be described hereinafter with reference to FIG. 3.

The nozzle 1 is inclined at a predetermined angle Θ with respect to a surface of the substrate G being transferred by rollers R (see FIG. 1). At this point, the second plate 5 having a lesser tip length is disposed on a downstream side with respect to an advancing direction (see arrow in FIG. 1) of the substrate G. When the fluid is injected through the fluid channel 9, the flow speed at a central axis of the fluid channel 9 becomes higher than that at a channel wall of the fluid channel 9 (see A in FIG. 3, a length of the arrow indicates flow speed of fluid). That is, since the outer circumferential fluid flowing along the channel 9 conflicts with the channel wall, the flow speed of the outer circumferential fluid becomes less than that of the central axis fluid. In addition, the flow speed is steeply increased in a moment when the fluid passes through the tip of the second plate 5 as the conflict with the channel wall disappears (See B in FIG. 3).

Accordingly, the fluid passing through the first and second plates 3 and 5 is injected as it is bent toward the first plate 3 having the longer tip. Furthermore, since the nozzle 1 is inclined with respect to the substrate G toward the direction where the substrate G is advanced, the fluid is injected to a direction opposite the direction where the substrate G is advanced. As a result, the generation of eddy current and negative pressure is suppressed at a portion of the first plate that corresponds to the first plate 5, thereby preventing the substrate G from vibrating to stably transfer the substrate G.

As described above, by allowing the fluid to be injected in a direction opposite to the substrate advancing direction, the treating efficiency of the substrate G can be remarkably improved.

In addition, even when the nozzle 1 is closely disposed to the substrate G, the distance between the tip of the second plate 5 and the substrate G can be maintained enough to prevent the substrate G from contacting the nozzle 1, which may be caused by the vibration of the rollers R.

As described above, since the injection nozzle is designed such that lengths of the tips are different from each other, the substrate treating efficiency can be improved even when the nozzle is not inclined.

When the nozzle is inclined such that a shorter tip is disposed close to the surface of the substrate, a gap between the tip and the substrate can be sufficiently maintained, preventing the nozzle from contacting the substrate and reducing defects of the products.

Furthermore, since the fluid is injected in a direction opposite to the substrate advancing direction, the generation of the eddy current and negative pressure can be suppressed, thereby preventing the vibration of the substrate to improve the substrate treating efficiency.

It will be apparent to those skilled in the art that various modifications and variations can be made in the disclosed injection nozzle. Thus, it is intended that the disclosure covers the modifications and variations provided they come within the scope of the appended claims and their equivalents.

1. A fluid injection nozzle for treating a substrate, comprising:
a first plate having a first tip; and
a second plate having a second tip, the second tip being coupled to the first plate by a fastener,
wherein the first and second plates define a fluid channel and the first and second tips have lengths different from each other.

2. The fluid injection nozzle of claim 1, wherein one of the first and second plates, which has the shorter tip, is disposed at a downstream side of the substrate with respect to a direction where the substrate is advanced.

3. A fluid injection nozzle for treating a substrate, comprising:
a first plate having a first tip;
a second plate having a second tip, the second tip being coupled to the first plate by a fastener, the first and second plates defining a fluid channel; and
means for injecting fluid passing through the fluid channel in a direction opposite to a direction where the substrate is advanced.

4. The fluid injection nozzle of claim 3 wherein the fluid injecting means is defined by making the first and second tips have lengths different from each other.
